(19) United States
(12) Patent Application Publication
(10) Pub. No.: US 2026/0081748 A1
(43) Pub. Date: Mar. 19, 2026

(54) SUB-BAND FULL DUPLEX OPERATION

(71) Applicant: Lenovo (Singapore) Pte. Limited, Singapore (SG)

(72) Inventor: Hyejung Jung, Northbrook, IL (US)

(73) Assignee: Lenovo (Singapore) Pte. Limited, Singapore (SG)

(21) Appl. No.: 19/108,873

(22) PCT Filed: Sep. 5, 2023
(86) PCT No.: PCT/IB2023/058788

§ 371 Date: Mar. 5, 2025

Related U.S. Application Data
(60) Provisional application No. 63/405,389, filed on Sep. 9, 2022.

(51) Int. Cl. H04L 5/14; H04L 5/00

(52) U.S. Cl. CPC H04L 5/14; H04L 5/0094

(57) ABSTRACT

Various aspects of the present disclosure relate to an apparatus, such as a user equipment (UE), that receives a full duplex sub-band configuration including multiple sub-bands of multiple bandwidths. The apparatus also receives a dynamic indication of an active sub-band selected from the multiple sub-bands, and performs a communication as at least one of a transmission or a reception according to the active sub-band. An apparatus, such as a base station, transmits a full duplex sub-band configuration to a UE, the full duplex sub-band configuration including multiple sub-bands of multiple bandwidths, and the base station transmits a dynamic indication of an active sub-band selected from the multiple sub-bands.

### RELATED APPLICATION

This application claims priority to U.S. Provisional Application Ser. No. 63/405,389 filed Sep. 9, 2022 entitled “Sub-Band Full Duplex Operation,” the disclosure of which is incorporated by reference herein in its entirety.

### TECHNICAL FIELD

The present disclosure relates to wireless communications, and more specifically to sub-band communications.

### BACKGROUND

A wireless communications system may include one or multiple network communication devices, such as base stations, which may be otherwise known as an eNodeB (eNB), a next-generation NodeB (gNB), or other suitable terminology. Each network communication devices, such as a base station may support wireless communications for one or multiple user communication devices, which may be otherwise known as user equipment (UE), or other suitable terminology. The wireless communications system may support wireless communications with one or multiple user communication devices by utilizing resources of the wireless communications system, such as time resources (e.g., symbols, slots, subframes, frames, or the like) or frequency resources (e.g., subcarriers, carriers). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

In an unpaired spectrum, time division duplex (TDD) is used to avoid interference (e.g. uplink (UL) and downlink (DL) interference) between a network entity and user equipment (UE), such as UE-to-UE interference. However, TDD limits UL and DL transmission opportunities, has a delay, and makes it difficult to accommodate urgent UL and DL transmissions simultaneously, particularly when DL and UL data traffic is asymmetric in a cell. While semi-static configuration of a full duplex UL (or DL) sub-band makes inter-gNB resource coordination and interference handling easier, radio resources may not be efficiently used.

### SUMMARY

The present disclosure relates to methods, apparatuses, and systems that support sub-band full duplex operation. Non-overlapping sub-band based full duplex operation in an unpaired spectrum can be implemented, such as for one sub-band of a carrier serves UL data traffic and another sub-band of the carrier serves DL data traffic. Aspects of this disclosure are described for flexible sub-band based full duplex operation in a cell, and corresponding DL reception (e.g., physical downlink shared channel (PDSCH)) and channel state information-reference signal (CSI-RS) reception (or UL transmission) methods at a UE in symbols configured with full duplex sub-bands. In aspects of sub-band full duplex operation, a network entity (e.g., a gNB) can be implemented for simultaneous reception and transmission, with a level of self-interference suppression, within a carrier, and the network entity can configure a first sub-band of a carrier as a UL resource and a second sub-band of the carrier not overlapping with the first sub-band as a DL resource for full duplex cell operation within the carrier, at least for a certain duration.

Full duplex operation by a network entity can reduce latency by allowing controlled UL and DL transmissions while on-going DL and UL data traffic is being served in a carrier. Further, dynamic bandwidth adaptation of a full duplex UL (or DL) sub-band among a set of configured sub-band bandwidths is beneficial for efficient resource utilization in response to the varying demands for UL and DL resources. Semi-static configuration of the set of sub-band bandwidths still makes interference management and coordination across neighboring cells feasible. Neighboring network entities (e.g., gNBs) can exchange information of a set of semi-statically configured sub-bands of a full duplex UL (or DL) sub-band configuration for interference management.

In some implementations of the method and apparatuses described herein, a UE receives a full duplex sub-band configuration including multiple sub-bands of multiple bandwidths. The UE receives a dynamic indication of an active sub-band selected from the multiple sub-bands, and performs a communication as at least one of a transmission or a reception according to the active sub-band.

Some implementations of the method and apparatuses described herein may further include the multiple sub-bands are included in a widest sub-band among the multiple sub-bands. The full duplex sub-band configuration is received as a full duplex UL sub-band configuration indicating multiple UL sub-bands, the active sub-band is an active UL sub-band, and the UE transmits the communication as an UL transmission within only the active UL sub-band in symbols configured based on the full duplex UL sub-band configuration. The UE receives a DL reception outside of the active UL sub-band in the symbols configured based on the full duplex UL sub-band configuration, and resource elements corresponding to the active UL sub-band are not available for the DL reception. The full duplex sub-band configuration is received as a full duplex DL sub-band configuration indicating multiple DL sub-bands, the active sub-band is an active DL sub-band, and the UE receives the communication as a DL reception within only the active DL sub-band in symbols configured based on the full duplex DL sub-band configuration. The UE transmits an UL transmission outside of the active DL sub-band in the symbols configured based on the full duplex DL sub-band configuration, and resource elements corresponding to the active DL sub-band are not available for the UL transmission.

Additionally, the multiple sub-bands include at least one sub-band with zero bandwidth. The UE determines a transport block size of a physical shared channel communicated outside of the active sub-band based on a number of physical resource blocks (PRBs) allocated for the physical shared channel, excluding at least one of the PRBs overlapping with a time and frequency resource of the active sub-band. The dynamic indication of the active sub-band is one of received in a medium access control (MAC) control element (CE), received in downlink control information (DCI) scheduling a physical shared channel, or received in DCI activating a semi-persistent scheduling (SPS) physical shared channel.

In some implementations of the method and apparatuses described herein, a base station transmits a full duplex sub-band configuration to a user equipment (UE), the full duplex sub-band configuration including multiple sub-bands of multiple bandwidths. The base station transmits a dynamic indication of an active sub-band selected from the multiple sub-bands.

Some implementations of the method and apparatuses described herein may further include the multiple sub-bands are included in a widest sub-band among the multiple sub-bands. The full duplex sub-band configuration is a full duplex UL sub-band configuration indicating multiple UL sub-bands, the active sub-band is an active UL sub-band, and the base station receives an UL transmission from the UE within only the active UL sub-band in symbols configured based on the full duplex UL sub-band configuration. The base station transmits a DL transmission to the UE outside of the active UL sub-band in the symbols configured based on the full duplex UL sub-band configuration, and resource elements corresponding to the active UL sub-band are not available for the DL transmission. The full duplex sub-band configuration is a full duplex DL sub-band configuration indicating multiple DL sub-bands, the active sub-band is an active DL sub-band, and the base station transmits a DL transmission to the UE within only the active DL sub-band in symbols configured based on the full duplex DL sub-band configuration. The base station receives an UL transmission from the UE outside of the active DL sub-band in the symbols configured based on the full duplex DL sub-band configuration, wherein resource elements corresponding to the active DL sub-band are not available for the UL transmission.

Additionally, the multiple sub-bands include at least one sub-band with zero bandwidth. The base station determines a transport block size of a physical shared channel communicated outside of the active sub-band based on a number of PRBs allocated for the physical shared channel, excluding at least one of the PRBs overlapping with a time and frequency resource of the active sub-band. The dynamic indication of the active sub-band is one of transmitted in a MAC CE, transmitted in DCI scheduling a physical shared channel, or transmitted in DCI activating a SPS physical shared channel. The base station transmits the full duplex sub-band configuration to a base station indicating at least one of an intended operation according to the multiple sub-bands of the multiple bandwidths, or an intended active sub-band selected from the multiple sub-bands.

### BRIEF DESCRIPTION OF THE DRAWINGS

FIG. 1 illustrates an example of a wireless communications system that supports sub-band full duplex operation in accordance with aspects of the present disclosure.

FIG. 2 illustrates an example of sub-band non-overlapping full duplex (SBFD) operation with sub-band bandwidth adaptation, which supports sub-band full duplex operation in accordance with aspects of the present disclosure.

FIG. 3 illustrates an example of an active full duplex UL (or DL) sub-band indication MAC CE, which supports sub-band full duplex operation in accordance with aspects of the present disclosure.

FIG. 4 illustrates a table of a full duplex sub-band rate matching indicator field in a DCI format, which supports sub-band full duplex operation in accordance with aspects of the present disclosure.

FIGS. 5 and 6 illustrate an example of a block diagram of devices that supports sub-band full duplex operation in accordance with aspects of the present disclosure.

FIGS. 7 through 10 illustrate flowcharts of methods that support sub-band full duplex operation in accordance with aspects of the present disclosure.

### DETAILED DESCRIPTION

In an unpaired spectrum, time division duplex (TDD) is used to avoid interference (e.g. UL and DL interference) between a network entity and a UE, such as UE-to-UE interference. However, TDD limits UL and DL transmission opportunities, has a delay, and makes it difficult to accommodate urgent UL and DL transmissions simultaneously, particularly when DL and UL data traffic is asymmetric in a cell. While semi-static configuration of a full duplex UL (or DL) sub-band makes inter-gNB resource coordination and interference handling easier, radio resources may not be efficiently used. To address interference handling, such as for self-interference and cross-link interference (e.g., UE-to-UE, base station (BS)-to-BS), non-overlapping sub-band based full duplex operation in an unpaired spectrum can be implemented, such as for one sub-band of a carrier serves UL data traffic and another sub-band of the carrier serves DL data traffic.

Aspects of this disclosure are described for flexible sub-band based full duplex operation in a cell, and corresponding DL reception (e.g., physical downlink shared channel (PDSCH)) and CSI-RS reception (or UL transmission) methods at a UE in symbols configured with full duplex sub-bands (e.g., a base station is implemented with the hardware to cancel interference). In aspects of sub-band full duplex operation, a network entity (e.g., a gNB) is capable of simultaneous reception and transmission (i.e., capable of full duplexing with a certain level of self-interference suppression) within a carrier, and the network entity can configure a first sub-band of a carrier as a UL resource and a second sub-band of the carrier not overlapping with the first sub-band as a DL resource for full duplex cell operation within the carrier, at least for a certain duration. In some examples, the first sub-band and the second sub-band may at least partially overlap.

With reference to bandwidth adaptation of a full duplex sub-band, a full duplex UL sub-band configuration includes multiple UL sub-bands with multiple bandwidths, and all of the UL sub-bands are within the widest UL sub-band. A UE further receives a dynamic indication of an active UL sub-band selected from the multiple UL sub-bands. For symbols configured with the full duplex UL sub-band, the UE does not expect to transmit outside the active UL sub-band. When the UE performs DL reception outside the active UL sub-band in symbols configured with the full duplex UL sub-band, the UE assumes that resource elements (REs) corresponding to the active sub-band are not available for the DL reception. Further, with reference to PDSCH reception with sub-band full duplex operation, a DCI bit field can be configured to dynamically indicate whether a UE performs rate matching around REs overlapping with a configured full duplex UL sub-band. The UE is configured with a list of partial UL sub-bands within the configured full duplex UL sub-band. A codepoint of the DCI bit field corresponds to a partial UL sub-band from the configured list of partial UL sub-bands, and one codepoint of the bit field is reserved for the full duplex UL sub-band.

Full duplex operation by a network entity can reduce latency by allowing controlled UL and DL transmissions while on-going DL and UL data traffic is being served in a carrier. Further, dynamic bandwidth adaptation of a full duplex UL (or DL) sub-band among a set of configured sub-band bandwidths is beneficial for efficient resource utilization in response to the varying demands for UL and DL resources. Semi-static configuration of the set of sub-band bandwidths still makes interference management and coordination across neighboring cells feasible. Neighboring network entities (e.g., gNBs) can exchange information of a set of semi-statically configured sub-bands of a full duplex UL (or DL) sub-band configuration for interference management.

Aspects of the present disclosure are described in the context of a wireless communications system. Aspects of the present disclosure are further illustrated and described with reference to device diagrams and flowcharts.

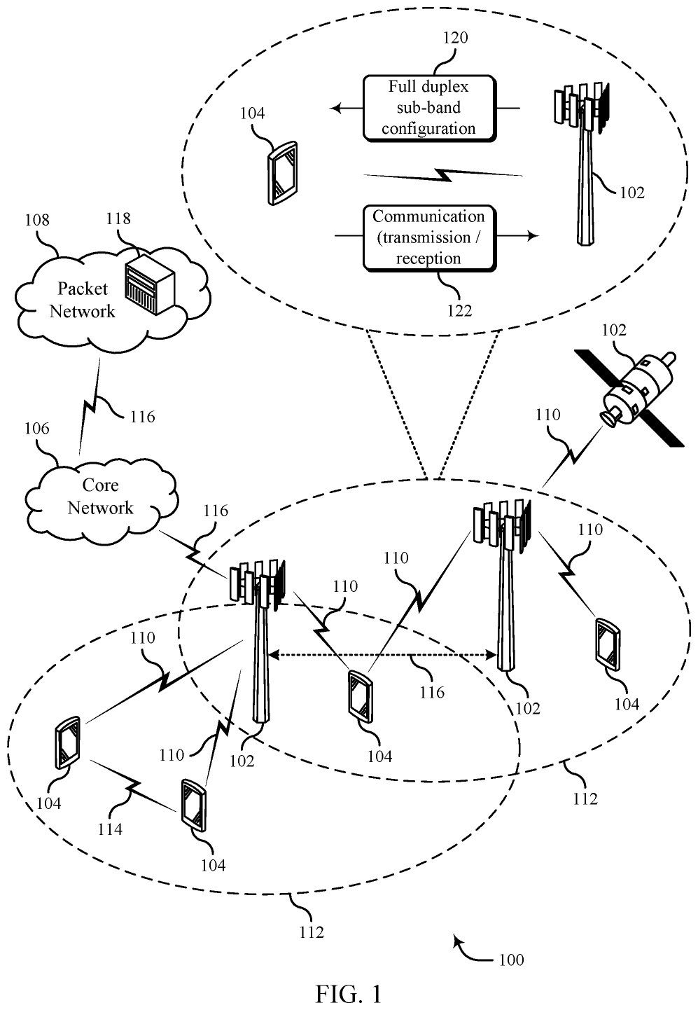

FIG. 1 illustrates an example of a wireless communications system 100 that supports sub-band full duplex operation in accordance with aspects of the present disclosure. The wireless communications system 100 may include one or more network entities 102, one or more UEs 104, a core network 106, and a packet data network 108. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a 5G network, such as an NR network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G. Additionally, the wireless communications system 100 may support technologies, such as time division multiple access (TDMA), frequency division multiple access (FDMA), or code division multiple access (CDMA), etc.

The one or more network entities 102 may be dispersed throughout a geographic region to form the wireless communications system 100. One or more of the network entities 102 described herein may be or include or may be referred to as a network node, a base station, a network element, a radio access network (RAN), a base transceiver station, an access point, a NodeB, an eNodeB (eNB), a next-generation NodeB (gNB), or other suitable terminology. A network entity 102 and a UE 104 may communicate via a communication link 110, which may be a wireless or wired connection. For example, a network entity 102 and a UE 104 may perform wireless communication (e.g., receive signaling, transmit signaling) over a Uu interface.

A network entity 102 may provide a geographic coverage area 112 for which the network entity 102 may support services (e.g., voice, video, packet data, messaging, broadcast, etc.) for one or more UEs 104 within the geographic coverage area 112. For example, a network entity 102 and a UE 104 may support wireless communication of signals related to services (e.g., voice, video, packet data, messaging, broadcast, etc.) according to one or multiple radio access technologies. In some implementations, a network entity 102 may be moveable, for example, a satellite associated with a non-terrestrial network. In some implementations, different geographic coverage areas 112 associated with the same or different radio access technologies may overlap, but the different geographic coverage areas 112 may be associated with different network entities 102. Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The one or more UEs 104 may be dispersed throughout a geographic region of the wireless communications system 100. A UE 104 may include or may be referred to as a mobile device, a wireless device, a remote device, a remote unit, a handheld device, or a subscriber device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples. In some implementations, a UE 104 may be stationary in the wireless communications system 100. In some other implementations, a UE 104 may be mobile in the wireless communications system 100.

The one or more UEs 104 may be devices in different forms or having different capabilities. Some examples of UEs 104 are illustrated in FIG. 1. A UE 104 may be capable of communicating with various types of devices, such as the network entities 102, other UEs 104, or network equipment (e.g., the core network 106, the packet data network 108, a relay device, an integrated access and backhaul (IAB) node, or another network equipment), as shown in FIG. 1. Additionally, or alternatively, a UE 104 may support communication with other network entities 102 or UEs 104, which may act as relays in the wireless communications system 100.

A UE 104 may also be able to support wireless communication directly with other UEs 104 over a communication link 114. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link 114 may be referred to as a sidelink. For example, a UE 104 may support wireless communication directly with another UE 104 over a PC5 interface.

A network entity 102 may support communications with the core network 106, or with another network entity 102, or both. For example, a network entity 102 may interface with the core network 106 through one or more backhaul links 116 (e.g., via an S1, N2, or another network interface). The network entities 102 may communicate with each other over the backhaul links 116 (e.g., via an X2, Xn, or another network interface). In some implementations, the network entities 102 may communicate with each other directly (e.g., between the network entities 102). In some other implementations, the network entities 102 may communicate with each other or indirectly (e.g., via the core network 106). In some implementations, one or more network entities 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

In some implementations, a network entity 102 may be configured in a disaggregated architecture, which may be configured to utilize a protocol stack physically or logically distributed among two or more network entities 102, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 102 may include one or more of a central unit (CU), a distributed unit (DU), a radio unit (RU), a RAN Intelligent Controller (RIC) (e.g., a Near-Real Time RIC (Near-RT RIC), a Non-Real Time RIC (Non-RT RIC)), a Service Management and Orchestration (SMO) system, or any combination thereof.

An RU may also be referred to as a radio head, a smart radio head, a remote radio head (RRH), a remote radio unit (RRU), or a transmission reception point (TRP). One or more components of the network entities 102 in a disaggregated RAN architecture may be co-located, or one or more components of the network entities 102 may be located in distributed locations (e.g., separate physical locations). In some implementations, one or more network entities 102 of a disaggregated RAN architecture may be implemented as virtual units (e.g., a virtual CU (VCU), a virtual DU (VDU), a virtual RU (VRU)).

Split of functionality between a CU, a DU, and an RU may be flexible and may support different functionalities depending upon which functions (e.g., network layer functions, protocol layer functions, baseband functions, radio frequency functions, and any combinations thereof) are performed at a CU, a DU, or an RU. For example, a functional split of a protocol stack may be employed between a CU and a DU such that the CU may support one or more layers of the protocol stack and the DU may support one or more different layers of the protocol stack. In some implementations, the CU may host upper protocol layer (e.g., a layer 3 (L3), a layer 2 (L2)) functionality and signaling (e.g., Radio Resource Control (RRC), service data adaption protocol (SDAP), Packet Data Convergence Protocol (PDCP)). The CU may be connected to one or more DUs or RUs, and the one or more DUs or RUs may host lower protocol layers, such as a layer 1 (L1) (e.g., physical (PHY) layer) or an L2 (e.g., radio link control (RLC) layer, medium access control (MAC) layer) functionality and signaling, and may each be at least partially controlled by the CU.

Additionally, or alternatively, a functional split of the protocol stack may be employed between a DU and an RU such that the DU may support one or more layers of the protocol stack and the RU may support one or more different layers of the protocol stack. The DU may support one or multiple different cells (e.g., via one or more RUs). In some implementations, a functional split between a CU and a DU, or between a DU and an RU may be within a protocol layer (e.g., some functions for a protocol layer may be performed by one of a CU, a DU, or an RU, while other functions of the protocol layer are performed by a different one of the CU, the DU, or the RU).

A CU may be functionally split further into CU control plane (CU-CP) and CU user plane (CU-UP) functions. A CU may be connected to one or more DUs via a midhaul communication link (e.g., F1, F1-c, F1-u), and a DU may be connected to one or more RUs via a fronthaul communication link (e.g., open fronthaul (FH) interface). In some implementations, a midhaul communication link or a fronthaul communication link may be implemented in accordance with an interface (e.g., a channel) between layers of a protocol stack supported by respective network entities 102 that are in communication via such communication links.

The core network 106 may support user authentication, access authorization, tracking, connectivity, and other access, routing, or mobility functions. The core network 106 may be an evolved packet core (EPC), or a 5G core (5GC), which may include a control plane entity that manages access and mobility (e.g., a mobility management entity (NMME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more network entities 102 associated with the core network 106.

The core network 106 may communicate with the packet data network 108 over one or more backhaul links 116 (e.g., via an S1, N2, or another network interface). The packet data network 108 may include an application server 118. In some implementations, one or more UEs 104 may communicate with the application server 118. A UE 104 may establish a session (e.g., a protocol data unit (PDU) session, or the like) with the core network 106 via a network entity 102. The core network 106 may route traffic (e.g., control information, data, and the like) between the UE 104 and the application server 118 using the established session (e.g., the established PDU session). The PDU session may be an example of a logical connection between the UE 104 and the core network 106 (e.g., one or more network functions of the core network 106).

In the wireless communications system 100, the network entities 102 and the UEs 104 may use resources of the wireless communications system 100, such as time resources (e.g., symbols, slots, subframes, frames, or the like) or frequency resources (e.g., subcarriers, carriers) to perform various operations (e.g., wireless communications). In some implementations, the network entities 102 and the UEs 104 may support different resource structures. For example, the network entities 102 and the UEs 104 may support different frame structures. In some implementations, such as in 4G, the network entities 102 and the UEs 104 may support a single frame structure. In some other implementations, such as in 5G and among other suitable radio access technologies, the network entities 102 and the UEs 104 may support various frame structures (i.e., multiple frame structures). The network entities 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. The first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. Each slot may include a number (e.g., quantity) of symbols (e.g., orthogonal frequency division multiplexing (OFDM) symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the network entities 102 and the UEs 104 may perform wireless communications over one or more of the operating frequency bands. In some implementations, FR1 may be used by the network entities 102 and the UEs 104, among other equipment or devices for cellular communications traffic (e.g., control information, data). In some implementations, FR2 may be used by the network entities 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

According to implementations, one or more of the network entities 102 and the UEs 104 are operable to implement various aspects of sub-band full duplex operation as described herein. For instance, a network entity 102 (e.g., a base station) communicates a full duplex sub-band configuration 120 to a UE 104, where the full duplex sub-band configuration includes multiple sub-bands of multiple bandwidths. In at least one implementation, the network entity 102 (e.g., a base station) also transmits a dynamic indication of an active sub-band selected from the multiple sub-bands to the UE. The UE 104 receives the full duplex sub-band configuration 120, as well as the dynamic indication of an active sub-band selected from the multiple sub-bands, and performs a communication 122 as one of a transmission or a reception according to the active sub-band.

For example, the UE 104 receives the full duplex sub-band configuration 120 as a full duplex UL sub-band configuration indicating multiple UL sub-bands, the active sub-band is an active UL sub-band, and the UE transmits the communication 122 as an UL transmission within only the active UL sub-band in symbols configured based on the full duplex UL sub-band configuration. The UE 104 can also receive a DL reception outside of the active UL sub-band in the symbols configured based on the full duplex UL sub-band configuration, and resource elements corresponding to the active UL sub-band are not available for the DL reception.

In another example, the UE 104 receives the full duplex sub-band configuration as a full duplex DL sub-band configuration indicating multiple DL sub-bands, the active sub-band is an active DL sub-band, and the UE receives the communication 122 as a DL reception within only the active DL sub-band in symbols configured based on the full duplex DL sub-band configuration. The UE 104 can also transmit an UL transmission outside of the active DL sub-band in the symbols configured based on the full duplex DL sub-band configuration, and resource elements corresponding to the active DL sub-band are not available for the UL transmission.

In aspects of sub-band full duplex operation, details of PDSCH resource allocation and resource mapping in 3GPP new radio (NR) are described. With reference to PDSCH resource allocation in frequency domain, a PDSCH scheduled with a DCI format 1_0 in any type of physical downlink control channel (PDCCH) common search space, regardless of which bandwidth part is the active bandwidth part, the resource block (RB) numbering starts from the lowest RB of the control resource set (CORESET) in which the DCI was received. Otherwise the RB numbering starts from the lowest RB in the determined downlink bandwidth part. When the PDCCH reception includes two PDCCH candidates from two respective search space sets, for the purpose of determining the downlink RB set of a PDSCH when scheduled by DCI format 1_0, the CORESET with the lower ID among two CORESETs associated with two PDCCH candidates is used.

With reference to PDSCH resource mapping with RB symbol level granularity, the procedures for PDSCH scheduled by PDCCH with DCI format 1_1 equally apply to PDSCH scheduled by PDCCH with DCI format 1_2, such as by applying the parameters of rateMatchPatternGroup1DCI-1-2, rateMatchPatternGroup2DCI-1-2 instead of rateMatchPatternGroup1 and rateMatchPatternGroup2. The procedures for PDSCH scheduled by PDCCH with DCI format 1_0 equally apply to PDSCH scheduled by PDCCH with DCI format 4_0, by applying the parameters of rateMatchPatternToAddModList configured in PDSCH-Config-MCCH or PDSCH-Config-MTCH (multicast traffic channel).

The procedures for PDSCH scheduled by PDCCH with DCI format 1_0 equally apply to PDSCH scheduled by PDCCH with DCI format 4_1, and the procedures for PDSCH scheduled by DCI format 1_1 equally apply to PDSCH scheduled by PDCCH with DCI format 4_2 by applying the parameters of rateMatchPatternToAddModList, rateMatchPatternGroup1 and rateMatchPatternGroup2 configured in PDSCH-Config-Multicast.

A UE can be configured with any of the following higher layer parameters indicating REs declared as not available for PDSCH: rateMatchPatternToAddModList given by PDSCH-Config, PDSCH-ConfigMulticast by ServingCellConfig or by ServingCellConfigCommon, or by PDSCH-Config-MCCH or PDSCH-Config-MTCH and configuring up to 4 RateMatchPattern(s) per bandwidth part (BWP) and up to 4 RateMatchPattern(s) per serving-cell. The RateMatchPatterns configured for multicast/broadcast services (MBS) multicast are counted into the ones that are configured per BWP. The RateMatchPattern(s) configured for MBS broadcast is counted into the ones that are configured per serving-cell.

A RateMatchPattern may contain within a BWP, when provided by PDSCH-Config or within a serving cell when provided by ServingCellConfig or ServingCellConfigCommon, or by PDSCH-Config-MCCH or PDSCH-Config-MTCH, a pair of reserved resources with numerology provided by higher layer parameter subcarrierSpacing given by RateMatchPattern when configured per serving cell or by numerology of associated BWP when configured per BWP. The pair of reserved resources are respectively indicated by an RB level bitmap (higher layer parameter resourceBlocks given by RateMatchPattern) with 1RB granularity and a symbol level bitmap spanning one or two slots (higher layer parameters symbolslnResourceBlock given by RateMatchPattern) for which the reserved RBs apply. A bit value equal to 1 in the RB and symbol level bitmaps indicates that the corresponding resource is not available for physical downlink shared channel (PDSCH). For each pair of RB and symbol level bitmaps, a UE may be configured with a time-domain pattern (higher layer parameter periodicityAndPattern given by RateMatchPattern), where each bit ofperiodicityAndPattern corresponds to a unit equal to a duration of the symbol level bitmap, and a bit value equal to 1 indicates that the pair is present in the unit. The periodicityAndPattern can be {1, 2, 4, 5, 8, 10, 20 or 40}units long, but a maximum of 40 msec. The first symbol ofperiodicityAndPattern every 40 msec/P periods is a first symbol in frame nf mod 4=0, where P is the duration of periodicityAndPattern in units of msec. When periodicityAndPattern is not configured for a pair, for a symbol level bitmap spanning two slots, the bits of the first and second slots correspond respectively to even and odd slots of a radio frame, and for a symbol level bitmap spanning one slot, the bits of the slot correspond to every slot of a radio frame. The pair can be included in one or two groups of resource sets (higher layer parameters rateMatchPatternGroup1 and rateMatchPatternGroup2). The rateMatchPatternToAddModList given by ServingCellConfig or ServingCellConfigCommon configuration in numerology u applies only to PDSCH of the same numerology u.

Further, a RateMatchPattern may contain within a BWP, a frequency domain resource of a CORESET configured by ControlResourceSet with controlResourceSetId or ControlResourceSetZero and time domain resource determined by the higher layer parameters monitoringSlotPeriodicityAndOffset, duration and monitoringSymbolsWithinSlot of all search-space-sets configured by SearchSpace and time domain resource of search-space-set zero configured by searchSpaceZero associated with the CORESET as well as CORESET duration configured by ControlResourceSet with controlResourceSetId or ControlResourceSetZero. This resource not available for PDSCH can be included in one or two groups of resource sets (higher layer parameters rateMatchPatternGroup1 and rateMatchPatternGroup2).

A configured group rateMatchPatternGroup1 or rateMatchPatternGroup2 contains a list of indices of RateMatchPattern(s) forming a union of resource-sets not available for a PDSCH dynamically if a corresponding bit of the ‘Rate matching indicator’ field of the DCI format 1_1 scheduling the PDSCH is equal to 1. The REs corresponding to the union of resource-sets configured by RateMatchPattern(s) that are not included in either of the two groups are not available for a PDSCH scheduled by a DCI format 1_0, a PDSCH scheduled by a DCI format 1_1, and PDSCHs with SPS. When receiving a PDSCH scheduled by a DCI format 1_0 or PDSCHs with SPS activated by a DCI format 1_0, the REs corresponding to configured resources in rateMatchPatternGroup1 or rateMatchPatternGroup2 are not available for the scheduled PDSCH or the activated PDSCHs with SPS. When receiving PDSCHs with SPS activated by a DCI format 1_1, the REs corresponding to configured resources in rateMatchPatternGroup1 or rateMatchPatternGroup2 are not available for the PDSCHs with SPS if a corresponding bit of the Rate matching indicator field of the DCI format 1_1 activating the PDSCHs with SPS is equal to 1. For a bitmap pair included in one or two groups of resource sets, the dynamic indication of availability for PDSCH applies to a set of slot(s), where the rateMatchPatternToAddModList is present among the slots of scheduled PDSCH.

If a UE monitors PDCCH candidates of aggregation levels 8 and 16 with the same starting control channel element (CCE) index in non-interleaved CORESET spanning one OFDM symbol, and if a detected PDCCH scheduling the PDSCH has aggregation level 8, the resources corresponding to the aggregation level 16 PDCCH candidate are not available for the PDSCH. When at least one of the PDCCH candidates of aggregation levels 8 and 16 linked as indicated by higher layer parameter searchSpaceLinking, the PDCCH candidates of aggregation level 16 and any other PDCCH candidate(s) linked with any of the PDCCH candidates of aggregation level 8 and 16 are not available for the PDSCH reception at the UE, if a detected PDCCH scheduling the PDSCH is associated with the PDCCH candidates of aggregation level 8 or 16.

If a PDSCH scheduled by a PDCCH would overlap with resources in the CORESET containing the PDCCH, the resources corresponding to a union of the detected PDCCH that scheduled the PDSCH and associated PDCCH demodulation reference signal (DM-RS) are not available for the PDSCH. When the PDCCH reception includes two PDCCH candidates from two respective search space sets, the resources corresponding to a union of the two PDCCH candidates scheduling the PDSCH and the associated PDCCH DM-RS are not available for the PDSCH. When precoderGranularity configured in a CORESET where the PDCCH was detected is set to ‘allContiguousRBs’, the associated PDCCH DM-RS are DM-RS in all REGs of the CORESET. Otherwise, the associated DM-RS are the DM-RS in REGs of the PDCCH.

With reference to PDSCH resource mapping with RE level granularity, the procedures for PDSCH scheduled by PDCCH with DCI format 1_1 as described equally apply to PDSCH scheduled by PDCCH with DCI format 1_2, by applying the parameters of aperiodicZP-CSI-RS-ResourceSetsToAddModListDCI-1-2 instead of aperiodic-ZP-CSI-RS-ResourceSetsToAddModList. The procedures for PDSCH scheduled by PDCCH with DCI format 1_0 as described equally apply to PDSCH scheduled by PDCCH with DCI format 4_1 and the procedures for PDSCH scheduled by PDCCH with DCI format 1_1 as described equally apply to PDSCH scheduled by PDCCH with DCI format 4_2, by applying the parameters of aperiodicZP-CSI-RS-ResourceSetsToAddModList in PDSCH-Config-Multicast instead of aperiodic-ZP-CSI-RS-ResourceSetsToAddModList in PDSCH-Config.

A UE can be configured with one or more higher layer parameters that include REs indicated by the ‘RateMatchPatternLTE-CRS’ in lte-CRS-ToMatchAround in ServingCellConfig or ServingCellConfigCommon configuring cell-specific RS, in 15 kHz subcarrier spacing applicable only to 15 kHz subcarrier spacing PDSCH, of one LTE carrier in a serving cell are declared as not available for PDSCH; and REs indicated by RateMatchPatternLTE-CRS' in lte-CRS-PatternList1-r16 in ServingCellConfig configuring cell-specific RS, in 15 kHz subcarrier spacing applicable only to 15 kHz subcarrier spacing PDSCH, of one LTE carrier in a serving cell are declared as not available for PDSCH. For the UE for broadcast reception, REs indicated by ‘RateMatchPatternLTE-CRS’ in PDSCH-Config-MCCH or PDSCH-Config-MCCH configuring cell-specific RS, in 15 kHz subcarrier spacing applicable only to 15 kHz subcarrier spacing PDSCH, of one LTE carrier in a serving cell are declared as not available for PDSCH.

Additionally, each RateMatchPatternLTE-CRS configuration contains v-Shift consisting of LTE-CRS-vshift(s), nrofCRS-Ports consisting of LTE-control resource set (CRS) antenna ports 1, 2 or 4 ports, carrierFreqDL representing the offset in units of 15 kHz subcarriers from (reference) point A to the LTE carrier center subcarrier location, carrierBandwidthDL representing the LTE carrier bandwidth, and may also configure mbsfn-SubframeConfigList representing multicast/broadcast, single frequency (MBSFN) subframe configuration. A UE determines the CRS position within the slot, where slot corresponds to LTE subframe.

If the UE is configured by higher layer parameter PDCCH-Config with two different values of coresetPoollndex in ControlResourceSet and is also configured by the higher layer parameter lte-CRS-PatternList1-r16 and lte-CRS-PatternList2-r16 in ServingCellConfig, the following REs are declared as not available for PDSCH: if the UE is configured with crs-RateMatch-PerCoresetPoollndex, REs indicated by the CRS pattern(s) in lte-CRS-PatternList1-r16 if the PDSCH is associated with coresetPoollndex set to ‘0’, or the CRS pattern(s) in lte-CRS-PatternList2-r16 if PDSCH is associated with coresetPoollndex set to ‘1’; otherwise, REs indicated by lte-CRS-PatternList1-r16 and lte-CRS-PatternList2-r16, in ServingCellConfig.

Within a BWP, the UE can be configured with one or more ZP CSI-RS resource set configuration(s) for aperiodic, semi-persistent and periodic time-domain behaviours (higher layer parameters aperiodic-ZP-CSI-RS-ResourceSetsToAddModList, sp-ZP-CSI-RS-ResourceSetsToAddModList and p-ZP-CSI-RS-ResourceSet respectively comprised in PDSCH-Config), with each ZP CSI-RS resource set consisting of at most 16 ZP CSI-RS resources (higher layer parameter ZP-CSI-RS-Resource) in numerology of the BWP. The REs indicated by p-ZP-CSI-RS-ResourceSet are declared as not available for PDSCH. The REs indicated by sp-ZP-CSI-RS-ResourceSetsToAddModList and aperiodic-ZP-CSI-RS-ResourceSetsToAddModList are declared as not available for PDSCH when their triggering and activation are applied, respectively. The following parameters are configured via higher layer signaling for each ZP CSI-RS resource configuration: zp-CSI-RS-Resourceld in ZP-CSI-RS-Resource determines ZP CSI-RS resource configuration identity; nrofPorts in CSI-RS-ResourceMapping defines the number of CSI-RS ports, where the allowable values are given; cdm-Type in CSI-RS-ResourceMapping defines CDM values and pattern, where the allowable values are given; resourceMapping in ZP-CSI-RS-Resource defines the OFDM symbol and subcarrier occupancy of the ZP CSI-RS resource within a slot that are given; and periodicityAndOffset in ZP-CSI-RS-Resource defines the ZP-CSI-RS periodicity and slot offset for periodic/semi-persistent ZP CSI-RS.

Additionally, for the UE in RRC_CONNECTED mode for multicast reception, p-ZP-CSI-RS-ResourceSet can be configured in PDSCH-Config-Multicast for GC-PDSCH rate matching, subject to UE capability. The REs indicated by p-ZP-CSI-RS-ResourceSet are declared as not available for GC-PDSCH. The REs indicated by p-ZP-CSI-RS-ResourceSet configured in PDSCH-Config for unicast do not apply for GC-PDSCH and the REs indicated by p-ZP-CSI-RS-ResourceSet configured in PDSCH-Config-Multicast for multicast do not apply for unicast PDSCH. The total number of periodic ZP-CSI-RS-Resources that a UE can be configured with is the same as for unicast in Rel-16. If p-ZP-CSI-RS-ResourceSet is configured in both PDSCH-Config and PDSCH-Config-Multicast, it is subject to UE capability whether the p-ZP-CSI-RS-ResourceSet configured in PDSCH-Config-Multicast can be different from the p-ZP-CSI-RS-ResourceSet configured in PDSCH-Config.

Further, for the UE in RRC_CONNECTED mode for multicast reception, sp-ZP-CSI-RS-ResourceSet can be configured in PDSCH-Config-Multicast for GC-PDSCH rate matching, subject to UE capability. The REs indicated by sp-ZP-CSI-RS-ResourceSet are declared as not available for GC-PDSCH when their triggering and activation delivered by unicast PDSCH are applied. The REs indicated by sp-ZP-CSI-RS-ResourceSet configured in PDSCH-Config for unicast do not apply for GC-PDSCH and the REs indicated by sp-ZP-CSI-RS-ResourceSet configured in PDSCH-Config-Multicast for multicast do not apply for unicast PDSCH. The total number of semi-persistent ZP-CSI-RS-Resources that a UE can be configured with is the same as for unicast.

A UE may be configured with a DCI field for triggering the aperiodic ZP CSI-RS. A list of ZP-CSI-RS-ResourceSet(s), provided by higher layer parameter aperiodic-ZP-CSI-RS-ResourceSetsToAddModList in PDSCH-Confizg, is configured for aperiodic triggering. The maximum number of aperiodic ZP-CSI-RS-ResourceSet(s) configured per BWP is 3. The bit-length of DCI field ZP CSI-RS trigger depends on the number of aperiodic ZP-CSI-RS-ResourceSet(s) configured (up to 2 bits). Each non-zero codepoint of ‘ZP CSI-RS’ trigger in DCI format 1_1 triggers one aperiodic ‘ZP-CSI-RS-ResourceSet’ in the list aperiodic-ZP-CSI-RS-ResourceSetsToAddModList by indicating the aperiodic ZP CSI-RS resource set ID. The DCI codepoint ‘01’ triggers the resource set with ‘ZP-CSI-RS-ResourceSetId’ set to ‘1’, the DCI codepoint ‘10’ triggers the resource set with ‘ZP-CSI-RS-ResourceSetId’ set to ‘2’, and the DCI codepoint ‘11’ triggers the resource set with ‘ZP-CSI-RS-ResourceSetId’ set to ‘3’. Codepoint ‘00’ is reserved for not triggering aperiodic ZP CSI-RS. When receiving PDSCH scheduled by DCI format 1_0 or PDSCHs with SPS activated by DCI format 1_0, the REs corresponding to configured resources in aperiodic-ZP-CSI-RS-ResourceSetsToAddModList or in aperiodicZP-CSI-RS-ResourceSetsToAddModListDCI-1-2 are available for PDSCH.

When the UE is configured with multi-slot and single-slot PDSCH scheduling, the triggered aperiodic ZP CSI-RS is applied to all the slot(s) of the PDSCH scheduled or the PDSCHs with SPS activated by the PDCCH containing the trigger.

In aspects of sub-band full duplex operation, when a network entity (e.g., a gNB) is capable of simultaneous reception and transmission (i.e., capable of full duplexing with a certain level of self-interference suppression) within a carrier, the network entity can configure a first sub-band of a carrier as a UL resource and a second sub-band of the carrier not overlapping with the first sub-band as a DL resource for full duplex cell operation within the carrier, at least for a certain duration. In some examples, the first sub-band and the second sub-band may at least partially overlap.

In implementations, a UE receives information of a time and frequency resource (i.e., full duplex UL sub-band) for UL transmission on at least some symbols configured as DL or as flexible symbols, and/or a time and frequency resource (i.e., full duplex DL sub-band) for DL reception on at least some symbols configured as UL or as flexible symbols, where the configuration of symbols as DL, UL, or flexible symbols is provided by tdd-UL-DL-ConfigurationCommon and additionally by tdd-UL-DL-ConfigurationDedicated, if configured. The information of full duplex UL sub-band and/or full duplex DL sub-band may be signaled as part of system information and/or as part of UE-specific configuration (e.g., bandwidth part configuration).

Further, a UE does not expect that a PDCCH monitoring occasion associated with CORESET0 (i.e., a control resource set with an identity value 0) of a cell overlaps with a time and frequency resource configured as a full duplex UL sub-band. In another implementation, a UE does not expect that a full duplex UL sub-band overlaps in frequency with any of a set of consecutive PRBs of CORESET0. Further, a UE configured with a full duplex UL sub-band in a set of symbols of a slot does not expect to be scheduled with an UL transmission outside the full duplex UL sub-band and does not expect to be scheduled with a DL reception within the full duplex UL sub-band in the set of symbols of the slot.

In one or more implementations, a UE configured with a full duplex UL sub-band in a set of symbols of a slot does not expect to be scheduled with an UL transmission outside the full duplex UL sub-band but may be scheduled with a DL reception within the full duplex UL sub-band in the set of symbols of the slot. A UE configured with a full duplex UL sub-band in a set of symbols of a slot does not expect to be scheduled with a DL transmission within the full duplex UL sub-band but may be scheduled with an UL reception outside the full duplex UL sub-band in the set of symbols of the slot. Further, a UE configured with a full duplex UL sub-band in a set of symbols of a slot may be scheduled with an UL transmission outside the full duplex UL sub-band and may be scheduled with a DL reception within the full duplex UL sub-band in the set of symbols of the slot.

With reference to bandwidth adaptation of a full duplex sub-band, a UE receives a full duplex UL (or DL) sub-band configuration for UL transmission (or DL reception) on at least some symbols configured as DL (or UL) or as flexible symbols, where the configuration of symbols as DL, UL, or flexible symbols is provided by tdd-UL-DL-ConfigurationCommon and additionally by tdd-UL-DL-ConfigurationDedicated, if configured. The full duplex UL (or DL) sub-band configuration includes multiple UL (or DL) sub-bands with multiple bandwidths, where all of the UL (or DL) sub-bands are within the widest UL (or DL) sub-band among the plurality of UL (or DL) sub-bands. The UE further receives a dynamic indication of an active UL (or DL) sub-band selected from the plurality of UL (or DL) sub-bands of the full duplex UL (or DL) sub-band configuration. For symbols configured with the full duplex UL (or DL) sub-band, the UE performs UL transmission (or DL reception) within the active UL (or DL) sub-band, and does not expect to transmit (or receive) outside the active UL (or DL) sub-band. When the UE performs DL reception (or UL transmission) outside the active UL (or DL) sub-band in symbols configured with the full duplex UL (or DL) sub-band, the UE assumes that REs corresponding to the active sub-band are not available for the DL reception (or the UL transmission).

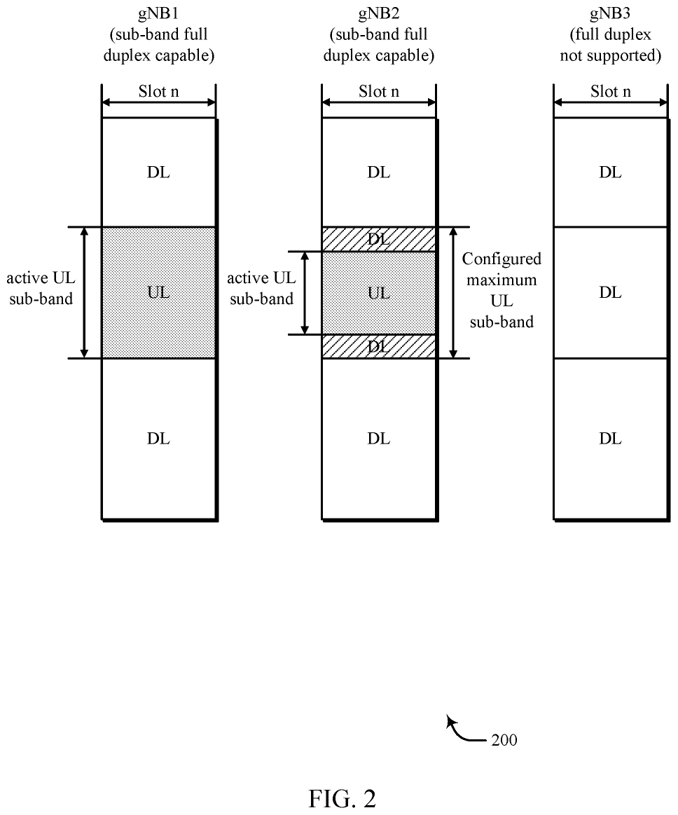

FIG. 2 illustrates an example 200 of sub-band non-overlapping full duplex (SBFD) operation with sub-band bandwidth adaptation, which supports sub-band full duplex operation in accordance with aspects of the present disclosure. Dynamic bandwidth adaptation of a full duplex UL (or DL) sub-band among a set of configured sub-band bandwidths is beneficial for efficient resource utilization in response to the varying demands for UL and DL resources. Semi-static configuration of the set of sub-band bandwidths still makes interference management and coordination across neighboring cells feasible. Neighboring network entities (e.g., gNBs) can exchange information of a set of semi-statically configured sub-bands of a full duplex UL (or DL) sub-band configuration.

In an implementation, a full duplex UL (or DL) sub-band configuration comprises a plurality of UL (or DL) sub-bands including a UL (or DL) sub-band with zero bandwidth. When the UL (or DL) sub-band with zero bandwidth is indicated as an active UL (or DL) sub-band, the UE assumes that the sub-band full duplex operation is deactivated.

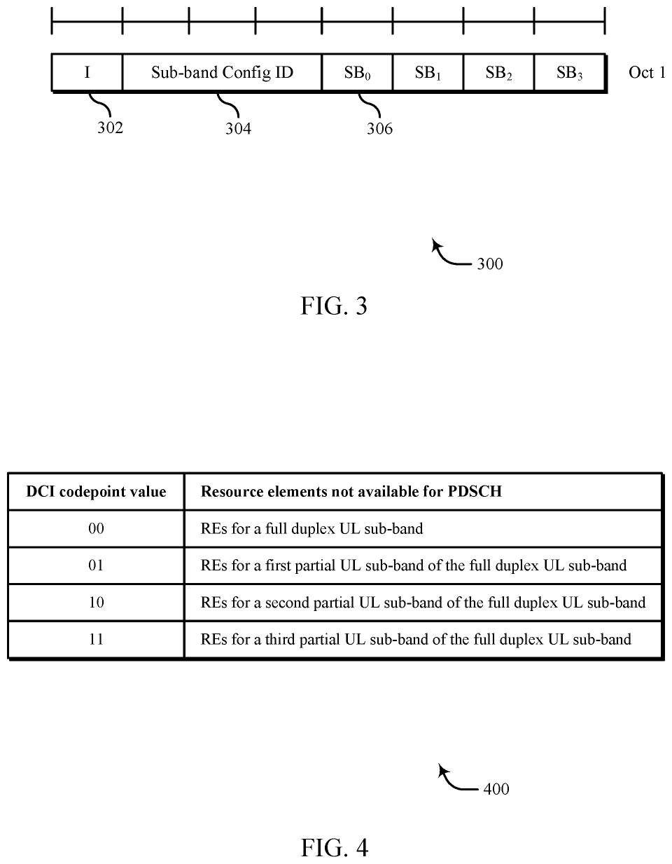

FIG. 3 illustrates an example of 300 of an active full duplex UL (or DL) sub-band indication MAC CE, which supports sub-band full duplex operation in accordance with aspects of the present disclosure. In an implementation, a MAC CE indicates an active UL (or DL) sub-band from a plurality of UL (or DL) sub-bands of a full duplex UL (or DL) sub-band configuration. For example, the MAC CE includes the fields of ‘I’ 302, a sub-band config ID 304, and SBᵢ 306. The ‘I’ field indicates whether this MAC CE applies to a full duplex UL sub-band configuration, or to a full duplex DL sub-band configuration. The ‘I’ field set to 1 indicates a full duplex UL sub-band configuration, whereas the field ‘I’ set to 0 indicates a full duplex DL sub-band configuration. The sub-band config ID field indicates a full duplex UL (or DL) sub-band configuration ID, and the length of the sub-band config ID field is 3 bits. The SBᵢ field indicates an activation or deactivation of a sub-band i in the full duplex UL (or DL) sub-band configuration indicated by the sub-band config ID field. The SBᵢ field set to 1 indicates that the sub-band i is an active sub-band, whereas the SBᵢ field set to 0 indicates that the sub-band i is a de-activated sub-band.

In an example, when a UE would transmit a physical uplink control channel (PUCCH) with hybrid automatic repeat request acknowledgement (HARQ-ACK) information in slot n corresponding to a PDSCH carrying an active full duplex UL (or DL) sub-band activation or deactivation command, a UE assumption on unavailable REs for DL reception (or UL transmission) corresponding to the activated UL (or DL) sub-band shall be applied starting from the first slot that is after slot

$$n + 3 {N}_{slot}^{subframe , μ} + \frac{{2}^{μ}}{{2}^{{μ}_{{K}_{mac}}}} \cdot {k}_{m a c}$$

where μ is the subcarrier spacing (SCS) configuration for the PUCCH and μ_{K}_{_{mac}} is the subcarrier spacing configuration for k_{mac} with a value of 0 for frequency range 1, and k_{mac} is provided by K-Mac or k_{mac}=0 if K-Mac is not provided.

With reference to PDSCH reception with sub-band full duplex operation, a UE receives a full duplex UL sub-band configuration that includes information of a time and frequency resource for UL transmission on at least some symbols configured as DL or flexible symbols, where the configuration of symbols as DL, UL, or flexible symbols is provided by tdd-UL-DL-ConfigurationCommon and additionally by tdd-UL-DL-ConfigurationDedicated, if configured. When the UE operates in a DL BWP, where the full duplex UL sub-band is configured within the DL BWP, the UE receives resource allocation information for a PDSCH, and receives the PDSCH on an allocated set of resource elements (REs) excluding a subset of REs of the set of REs overlapping with the full duplex UL sub-band. For example, the UE receives the PDSCH on the allocated set of REs with rate-matching around the subset of REs of the set of REs overlapping with the full duplex UL sub-band. In another example, the UE receives the PDSCH on the allocated set of REs with puncturing (i.e., not using) the subset of REs of the set of REs overlapping with the full duplex UL sub-band.

FIG. 4 illustrates a table 400 of a full duplex sub-band rate matching indicator field in a DCI format, which supports sub-band full duplex operation in accordance with aspects of the present disclosure. In an implementation, a UE receives a dynamic indication (e.g., via DCI scheduling a PDSCH or DCI activating a SPS PDSCH) indicating whether the UE should exclude (e.g., rate-matching around or puncturing) REs that are allocated for PDSCH and overlap with a full duplex UL sub-band to receive the PDSCH (or the SPS PDSCH). In an example, a ‘rate matching indicator’ field in a DCI format is extended up to 3 bits.

In this example, the rate matching indicator is 0, 1, 2, or 3 bits according to higher layer parameters rateMatchPatternGroup1 and rateMatchPatternGroup2, where the MSB is used to indicate rateMatchPatternGroup1 and the least significant bit (LSB) is used to indicate rateMatchPatternGroup2 when there are two groups. According to higher layer parameters rateMatchPatternGroup1, rateMatchPatternGroup2, and rateMatchFullDuplexSubband, where each of 2 bits starting from the MSB is used to indicate rateMatchPatternGroup1 and rateMatchPatternGroup2, respectively, and the LSB is used to indicate rateMatchFullDuplexSubband according to higher layer parameters rateMatchPatternGroup1 and rateMatchFullDuplexSubband where the MSB is used to indicate rateMatchPatternGroup1 and the LSB is used to indicate rateMatchFullDuplexSubband. The higher layer parameter rateMatchFullDuplexSubband includes information of a rate matching pattern(s) related to a full duplex UL sub-band(s). If rateMatchFullDuplexSubband includes, or is associated with, information of two rate matching patterns, the bit value 0 indicates rate-matching according to a first rate matching pattern (e.g., all REs of the full duplex UL sub-band(s) are not available for PDSCH), and the bit value 1 indicates rate-matching according to a second rate matching pattern (e.g., a subset of REs of the full duplex UL sub-band(s) are not available for PDSCH).

In another example, a ‘full duplex sub-band rate matching indicator’ field (e.g., 2 bits as shown in the table 400 of FIG. 4) is configured in a DCI format to dynamically indicate whether a UE performs rate matching around REs overlapping with a configured full duplex UL sub-band(s). For example, a UE configured with a full duplex UL sub-band(s) can also be configured with a higher layer parameter partialFullDuplexSubbandList comprising information of a list of partial UL sub-bands within the configured full duplex UL sub-band. A codepoint of the ‘full duplex sub-band rate matching indicator’ field corresponds to a partial UL sub-band from the configured list of partial UL sub-bands, and one codepoint of the bit field is reserved for the full duplex UL sub-band, as shown in the table 400 of FIG. 4. The UE assumes that REs corresponding to an indicated partial UL sub-band or the indicated full duplex UL sub-band are not available for PDSCH.

The described PDSCH reception method allows a network entity to dynamically and/or partially use a semi-statically configured full duplex UL sub-band for DL transmission, when the network entity does not expect, or does not intend to receive, any UL transmission from any UE in the configured full duplex UL sub-band. In another implementation, a UE always excludes REs overlapping with a configured full duplex UL sub-band(s) for DL reception (e.g. PDSCH, CSI-RS, and PDCCH), if a dynamic indication of rate matching or puncturing of the overlapping REs is not configured. Further, the UE does not expect that any RE of a SS/physical broadcast channel (PBCH) block indicated as being transmitted overlaps with a configured full duplex UL sub-band.

In an example, for downlink resource allocation of type 0, resource block assignment information includes a bitmap with one bit per resource block group (RBG) (or resource block groups) indicating one or multiple RBGs that are allocated to a UE, where a RBG is a set of consecutive virtual resource blocks defined by higher layer parameter rbg-Size configured by PDSCH-Config and a size of a bandwidth part. If a downlink resource allocation of type 0 is scheduled using a DCI with cyclic redundancy check (CRC) scrambled by G-radio network temporary identifier (RNTI) or G-configured scheduling (CS)-RNTI, a RBG is a set of consecutive virtual resource blocks defined by higher layer parameter rbg-Size configured by PDSCH-Config-Multicast and a size of a common frequency resource (CFR).

The total number of RBGs (N_{RBG}) for a downlink bandwidth part i of size

$${N}_{BWP , i}^{s i z e}$$

PRBs is given by

$${N}_{R B G} = ⌈ ( {N}_{B W P , i}^{s i z e} + ( {N}_{B WP , i}^{start} mod P ) ) / P ⌉ ,$$

where the size of the first RBG is

$$R B {G}_{0}^{s i z e} = P - {N}_{B WP , i}^{start} mod P - {U}_{0} ,$$

where U₀ is the number RBs configured for a full duplex UI

$$R B {G}_{last}^{s i z e} = ( {N}_{B WP , i}^{start} + {N}_{B W P , i}^{s i z e} ) mod P - {U}_{last} if ( {N}_{B WP , i}^{start} + {N}_{B W P , i}^{s i z e} ) mod P > 0$$

and P-Uₗₐₛₜ otherwise, where Uₗₐₛₜ is the number RBs configured for the full duplex UL sub-band within the last RBG; and the size of RBG i excluding the first and last RBGs, P-Uᵢ, where Uᵢ is the number RBs configured for the full duplex UL sub-band within the RBG i.

In another example, for downlink resource allocation of type 1, the resource block assignment information indicates to a scheduled UE a set of contiguously allocated non-interleaved or interleaved virtual resource blocks (VRBs) within an active bandwidth part of size

$${N}_{BWP}^{s i z e}$$

PRBs with exclusion of a number of PRBs overlapping with a full duplex UL sub-band except for the case when DCI format 1_0 is decoded in any common search space. In this case, the size of CORESET 0 with exclusion of the number of PRBs overlapping with the full duplex UL sub-band is used if CORESET 0 is configured for the cell and the size of initial DL bandwidth part with exclusion of the number of PRBs overlapping with the full duplex UL sub-band is used if CORESET 0 is not configured for the cell.

A downlink type 1 resource allocation field consists of a resource indication value (RIV) corresponding to a starting virtual resource block (RBₛₜₐᵣₜ) and a length in terms of contiguously allocated resource blocks L_{RBs}. The resource indication value is defined by:

$$if ( {L}_{RBs} - 1 ) \leq ⌊ {N}_{BWP}^{size} / 2 ⌋ then RIV = {N}_{BWP}^{size} ( {L}_{RBs} - 1 ) + {RB}_{start} else RIV = {N}_{BWP}^{size} ( {N}_{BWP}^{size} - {L}_{RBs} + 1 ) + ( {N}_{BWP}^{size} - 1 - {RB}_{start} )$$

where L_{RBs}≥1 and shall not exceed

$${N}_{BWP}^{size} - {RB}_{start} .$$

In an implementation,

$${N}_{BWP}^{size}$$

denotes a number of PRBs within an active bandwidth part that do not overlap with a time and frequency resource of a configured full duplex UL sub-band, or alternatively, a time and frequency resource of an active full duplex UL sub-band. For interleaved VRB-to-PRB mapping, resource block bundles are defined based on resource blocks that do not overlap with a time and frequency resource of the configured full duplex UL sub-band, or alternatively, a time and frequency resource of the active full duplex UL sub-band.

In an implementation with reference to transport block size (TBS) determination, when a UE determines a TBS of a PDSCH (or a physical uplink shared channel (PUSCH)), the UE determines a number of PRBs allocated for the PDSCH (or the PUSCH) by excluding one or more PRBs overlapping with a time and frequency resource of a full duplex UL sub-band. For example, a UE determines a transport block size (TBS) as detailed below in steps (1-4).

In step 1), the UE first determines the number of REs (N_{RE}) within a slot. The UE determines the number of REs allocated for PDSCH within a PRB (N′_{RE}) by

$${N}_{RE}^{′} = {N}_{sc}^{RB} \cdot {N}_{symb}^{sh} - {N}_{DMRS}^{PRB} - {N}_{oh}^{PRB} , where {N}_{sc}^{RB} = 12$$

is the number of subcarriers in a physical resource block; N_{symb}^{sh} is the number of symbols of the PDSCH allocation within the slot;

$${N}_{DMRS}^{PRB}$$

is the number of REs for DM-RS per PRB in the scheduled duration including the overhead of the DM-RS code division multiplex (CDM) groups without data, as indicated by DCI format 1_1 or format 1_2 or as described for format 1_0 [clause 5.1.6.2]; and

$${N}_{oh}^{PRB}$$

is the overhead configured by higher layer parameter xOverhead in PDSCH-ServingCellConfig. If the xOverhead in PDSCH-ServingCellconfg is not configured (a value from 6, 12, or 18), then the

$${N}_{oh}^{PRB}$$

is set to 0. If the PDSCH is scheduled by PDCCH with a CRC scrambled by SI-RNTI, RA-RNTI, MSGB-RNTI or P-RNTI,

$${N}_{oh}^{PRB}$$

is assumed to be 0. If the PDSCH is scheduled by PDCCH with a CRC scrambled by G-RNTI or G-CS-RNTI or PDSCH without PDCCH is activated by PDCCH with a CRC scrambled by G-CS-RNTI,

$${N}_{oh}^{PRB}$$

is the overhead configured by higher layer parameter xOverhead-Multicast in PDSCH-Config-Multicast. If the xOverhead-Multicast in PDSCH-Config-Multicast is not configured, the

$${N}_{oh}^{PRB}$$

is set to 0. Further, the UE determines the total number of REs allocated for PDSCH (N_{RE}) by N_{RE}=min(156, N′_{RE})·n_{PRB}, where n_{PRB} is the total number of allocated PRBs for the UE excluding one or more PRBs overlapping with a time and frequency resource of a full duplex UL sub-band.

In step 2) a UE determines a TBS, an unquantized intermediate variable (N_{info}) is obtained by N_{info}=N_{RE}·R·Qₘ·υ. If N_{info}≤3824, then step 3) is used as the next step of the TBS determination, else step 4) is used as the next step of the TBS determination.

In step 3), when N_{info}≤3824, TBS is determined based on a quantized intermediate number of information bits

$${N}_{info}^{′} = max ( 24 , {2}^{n} \cdot ⌊ \frac{{N}_{info}}{{2}^{n}} ⌋ ) ,$$

where n=max(3, └log₂ N_{info}┘−6), and use Table 5.1.3.2-1 to find the closest TBS that is not less than N′_{info}.

In step 4), when N_{info}>3824, TBS is determined based on a quantized intermediate number of information bits

$${N}_{info}^{′} = max ( 3840 , {2}^{n} \times round ( \frac{{N}_{info} - 24}{{2}^{n}} ) ) ,$$

where n=└log₂(N_{info}−24)┘−5 and ties in the round function are broken towards the next largest integer. If R≤¼, then

$$TBS = 8 \cdot C \cdot ⌈ \frac{{N}_{info}^{′} + 24}{8 \cdot C} ⌉ - 24 , where C = ⌈ \frac{{N}_{info}^{′} + 24}{3816} ⌉ ,$$

else if N′_{info}>8484, then

$$TBS = 8 \cdot C \cdot ⌈ \frac{{N}_{info}^{′} + 24}{8 \cdot C} ⌉ - 24 , where C = ⌈ \frac{{N}_{info}^{′} + 24}{8424} ⌉ ,$$

else

$$TBS = 8 \cdot ⌈ \frac{{N}_{info}^{′} + 24}{8} ⌉ - 24.$$

Otherwise, if Table 5.1.3.1-2 [TS38.214] is used and 28≤I_{MCS}≤31, then the TBS is assumed to be as determined from the DCI transported in the latest PDCCH for the same transport block using 0≤I_{MCS}≤27. If there is no PDCCH for the same transport block using 0 I_{MCS}≤27, and if the initial PDSCH for the same transport block is semi-persistently scheduled, the TBS shall be determined from the most recent semi-persistent scheduling assignment PDCCH. Else if Table 5.1.3.1-4 [TS38.214] is used and 27≤I_{MCS}≤31, then the TBS is assumed to be as determined from the DCI transported in the latest PDCCH for the same transport block using 0≤I_{MCS}≤26. If there is no PDCCH for the same transport block using 0≤I_{MCS}≤26, and if the initial PDSCH for the same transport block is semi-persistently scheduled, the TBS shall be determined from the most recent semi-persistent scheduling assignment PDCCH. Else the TBS is assumed to be as determined from the DCI transported in the latest PDCCH for the same transport block using 0≤I_{MCS}≤28. If there is no PDCCH for the same transport block using 0≤I_{MCS}≤28, and if the initial PDSCH for the same transport block is semi-persistently scheduled, the TBS shall be determined from the most recent semi-persistent scheduling assignment PDCCH.

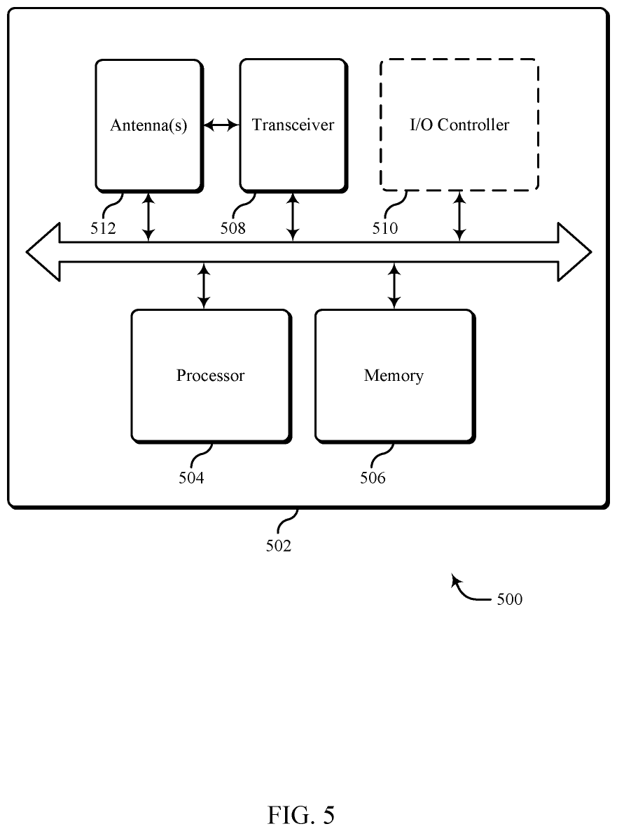

FIG. 5 illustrates an example of a block diagram 500 of a device 502 that supports sub-band full duplex operation in accordance with aspects of the present disclosure. The device 502 may be an example of a UE 104 as described herein. The device 502 may support wireless communication with one or more network entities 102, UEs 104, or any combination thereof. The device 502 may include components for bi-directional communications including components for transmitting and receiving communications, such as a processor 504, a memory 506, a transceiver 508, and an I/O controller 510. These components may be in electronic communication or otherwise coupled (e.g., operatively, communicatively, functionally, electronically, electrically) via one or more interfaces (e.g., buses).

The processor 504, the memory 506, the transceiver 508, or various combinations thereof or various components thereof may be examples of means for performing various aspects of the present disclosure as described herein. For example, the processor 504, the memory 506, the transceiver 508, or various combinations or components thereof may support a method for performing one or more of the operations described herein.

In some implementations, the processor 504, the memory 506, the transceiver 508, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 504 and the memory 506 coupled with the processor 504 may be configured to perform one or more of the functions described herein (e.g., executing, by the processor 504, instructions stored in the memory 506).

For example, the processor 504 may support wireless communication at the device 502 in accordance with examples as disclosed herein. The processor 504 may be configured as or otherwise support a means for receiving a full duplex sub-band configuration including multiple sub-bands of multiple bandwidths; receiving a dynamic indication of an active sub-band selected from the multiple sub-bands; and performing a communication as at least one of a transmission or a reception according to the active sub-band.

Additionally, the processor 504 may be configured as or otherwise support any one or combination of the multiple sub-bands are included in a widest sub-band among the multiple sub-bands. The full duplex sub-band configuration is received as a full duplex UL sub-band configuration indicating multiple UL sub-bands; the active sub-band is an active UL sub-band; and the method further comprising transmitting the communication as an UL transmission within only the active UL sub-band in symbols configured based at least in part on the full duplex UL sub-band configuration. The method further comprising receiving a DL reception outside of the active UL sub-band in the symbols configured based at least in part on the full duplex UL sub-band configuration, wherein resource elements corresponding to the active UL sub-band are not available for the DL reception. The full duplex sub-band configuration is received as a full duplex DL sub-band configuration indicating multiple DL sub-bands; the active sub-band is an active DL sub-band; and the method further comprising receiving the communication as a DL reception within only the active DL sub-band in symbols configured based at least in part on the full duplex DL sub-band configuration. The method further comprising transmitting an UL transmission outside of the active DL sub-band in the symbols configured based at least in part on the full duplex DL sub-band configuration, wherein resource elements corresponding to the active DL sub-band are not available for the UL transmission. The multiple sub-bands include at least one sub-band with zero bandwidth. The method further comprising determining a transport block size of a physical shared channel communicated outside of the active sub-band based at least in part on a number of PRBs allocated for the physical shared channel, excluding at least one of the PRBs overlapping with a time and frequency resource of the active sub-band. The dynamic indication of the active sub-band is received in a MAC CE. The dynamic indication of the active sub-band is received in DCI scheduling a physical shared channel. The dynamic indication of the active sub-band is received in DCI activating a SPS physical shared channel.

Additionally, or alternatively, the device 502, in accordance with examples as disclosed herein, may include a processor and a memory coupled with the processor, the processor configured to: receive a full duplex sub-band configuration including multiple sub-bands of multiple bandwidths; receive a dynamic indication of an active sub-band selected from the multiple sub-bands; and perform a communication as at least one of a transmission or a reception according to the active sub-band.

Additionally, the wireless communication at the device 502 may include any one or combination of the multiple sub-bands are included in a widest sub-band among the multiple sub-bands. The full duplex sub-band configuration is received as a full duplex UL sub-band configuration indicating multiple UL sub-bands; the active sub-band is an active UL sub-band; and the processor is configured to transmit the communication as an UL transmission within only the active UL sub-band in symbols configured based at least in part on the full duplex UL sub-band configuration. The processor is configured to receive a DL reception outside of the active UL sub-band in the symbols configured based at least in part on the full duplex UL sub-band configuration, wherein resource elements corresponding to the active UL sub-band are not available for the DL reception. The full duplex sub-band configuration is received as a full duplex DL sub-band configuration indicating multiple DL sub-bands; the active sub-band is an active DL sub-band; and the processor is configured to receive the communication as a DL reception within only the active DL sub-band in symbols configured based at least in part on the full duplex DL sub-band configuration. The processor is configured to transmit an UL transmission outside of the active DL sub-band in the symbols configured based at least in part on the full duplex DL sub-band configuration, wherein resource elements corresponding to the active DL sub-band are not available for the UL transmission. The multiple sub-bands include at least one sub-band with zero bandwidth. The processor is configured to determine a transport block size of a physical shared channel communicated outside of the active sub-band based at least in part on a number of PRBs allocated for the physical shared channel, excluding at least one of the PRBs overlapping with a time and frequency resource of the active sub-band. The dynamic indication of the active sub-band is received in a MAC CE. The dynamic indication of the active sub-band is received in DCI scheduling a physical shared channel. The dynamic indication of the active sub-band is received in DCI activating a SPS physical shared channel.

The processor 504 of the device 502, such as a UE 104, may support wireless communication in accordance with examples as disclosed herein. The processor 504 includes at least one controller coupled with at least one memory, and is configured to or operable to cause the processor to receive a full duplex sub-band configuration including multiple sub-bands of multiple bandwidths; receive a dynamic indication of an active sub-band selected from the multiple sub-bands; and perform a communication as at least one of a transmission or a reception according to the active sub-band.

The processor 504 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 504 may be configured to operate a memory array using a memory controller. In some other implementations, a memory controller may be integrated into the processor 504. The processor 504 may be configured to execute computer-readable instructions stored in a memory (e.g., the memory 506) to cause the device 502 to perform various functions of the present disclosure.

The memory 506 may include random access memory (RAM) and read-only memory (ROM). The memory 506 may store computer-readable, computer-executable code including instructions that, when executed by the processor 504 cause the device 502 to perform various functions described herein. The code may be stored in a non-transitory computer-readable medium such as system memory or another type of memory. In some implementations, the code may not be directly executable by the processor 504 but may cause a computer (e.g., when compiled and executed) to perform functions described herein. In some implementations, the memory 506 may include, among other things, a basic I/O system (BIOS) which may control basic hardware or software operation such as the interaction with peripheral components or devices.

The I/O controller 510 may manage input and output signals for the device 502. The I/O controller 510 may also manage peripherals not integrated into the device M02. In some implementations, the I/O controller 510 may represent a physical connection or port to an external peripheral. In some implementations, the I/O controller 510 may utilize an operating system such as iOS®, ANDROID®, MS-DOS®, MS-WINDOWS®, OS/2®, UNIX®, LINUX®, or another known operating system. In some implementations, the I/O controller 510 may be implemented as part of a processor, such as the processor 504. In some implementations, a user may interact with the device 502 via the I/O controller 510 or via hardware components controlled by the I/O controller 510.

In some implementations, the device 502 may include a single antenna 512. However, in some other implementations, the device 502 may have more than one antenna 512 (i.e., multiple antennas), including multiple antenna panels or antenna arrays, which may be capable of concurrently transmitting or receiving multiple wireless transmissions. The transceiver 508 may communicate bi-directionally, via the one or more antennas 512, wired, or wireless links as described herein. For example, the transceiver 508 may represent a wireless transceiver and may communicate bi-directionally with another wireless transceiver. The transceiver 508 may also include a modem to modulate the packets, to provide the modulated packets to one or more antennas 512 for transmission, and to demodulate packets received from the one or more antennas 512.

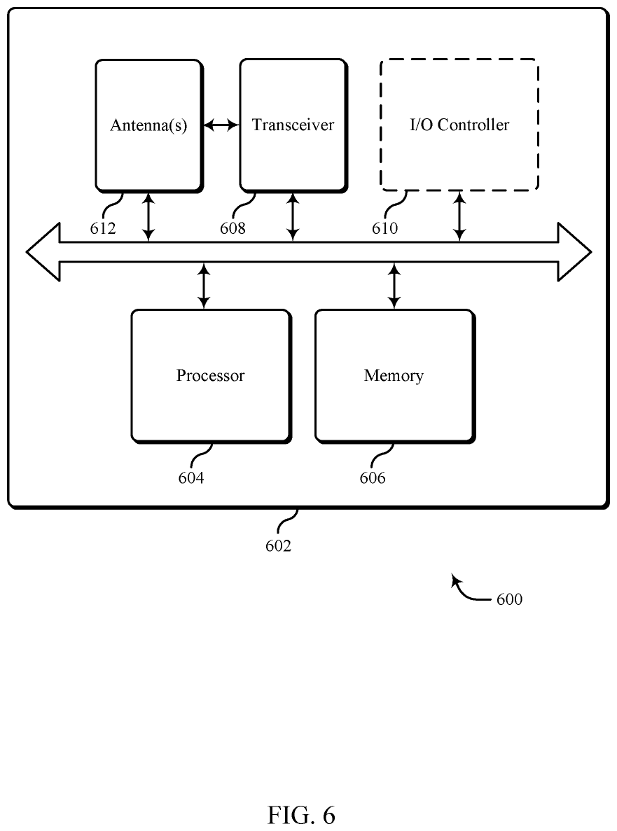

FIG. 6 illustrates an example of a block diagram 600 of a device 602 that supports sub-band full duplex operation in accordance with aspects of the present disclosure. The device 602 may be an example of a network entity 102, such as a base station as described herein. The device 602 may support wireless communication with one or more network entities 102, UEs 104, or any combination thereof. The device 602 may include components for bi-directional communications including components for transmitting and receiving communications, such as a processor 604, a memory 606, a transceiver 608, and an I/O controller 610. These components may be in electronic communication or otherwise coupled (e.g., operatively, communicatively, functionally, electronically, electrically) via one or more interfaces (e.g., buses).

The processor 604, the memory 606, the transceiver 608, or various combinations thereof or various components thereof may be examples of means for performing various aspects of the present disclosure as described herein. For example, the processor 604, the memory 606, the transceiver 608, or various combinations or components thereof may support a method for performing one or more of the operations described herein.

In some implementations, the processor 604, the memory 606, the transceiver 608, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 604 and the memory 606 coupled with the processor 604 may be configured to perform one or more of the functions described herein (e.g., executing, by the processor 604, instructions stored in the memory 606).

For example, the processor 604 may support wireless communication at the device 602 in accordance with examples as disclosed herein. The processor 604 may be configured as or otherwise support a means for transmitting a full duplex sub-band configuration to a UE, the full duplex sub-band configuration including multiple sub-bands of multiple bandwidths; and transmitting a dynamic indication of an active sub-band selected from the multiple sub-bands.

Additionally, the processor 604 may be configured as or otherwise support any one or combination of the multiple sub-bands are included in a widest sub-band among the multiple sub-bands. The full duplex sub-band configuration is a full duplex UL sub-band configuration indicating multiple UL sub-bands; the active sub-band is an active UL sub-band; and the method further comprising receiving an UL transmission from the UE within only the active UL sub-band in symbols configured based at least in part on the full duplex UL sub-band configuration. The method further comprising transmitting a DL transmission to the UE outside of the active UL sub-band in the symbols configured based at least in part on the full duplex UL sub-band configuration, wherein resource elements corresponding to the active UL sub-band are not available for the DL transmission. The full duplex sub-band configuration is a full duplex DL sub-band configuration indicating multiple DL sub-bands; the active sub-band is an active DL sub-band; and the method further comprising transmitting a DL transmission to the UE within only the active DL sub-band in symbols configured based at least in part on the full duplex DL sub-band configuration. The method further comprising receiving an UL transmission from the UE outside of the active DL sub-band in the symbols configured based at least in part on the full duplex DL sub-band configuration, wherein resource elements corresponding to the active DL sub-band are not available for the UL transmission. The multiple sub-bands include at least one sub-band with zero bandwidth. The method further comprising determining a transport block size of a physical shared channel communicated outside of the active sub-band based at least in part on a number of PRBs allocated for the physical shared channel, excluding at least one of the PRBs overlapping with a time and frequency resource of the active sub-band. The dynamic indication of the active sub-band is transmitted in a MAC CE. The dynamic indication of the active sub-band is transmitted in DCI scheduling a PDSCH. The dynamic indication of the active sub-band is transmitted in DCI activating a SPS PDSCH. The method further comprising transmitting the full duplex sub-band configuration to a base station indicating an intended operation according to the multiple sub-bands of the multiple bandwidths. The indicating the intended operation further comprises indicating an intended active sub-band selected from the multiple sub-bands.

Additionally, or alternatively, the device 602, in accordance with examples as disclosed herein, may include a processor and a memory coupled with the processor, the processor configured to: transmit a full duplex sub-band configuration to a UE, the full duplex sub-band configuration including multiple sub-bands of multiple bandwidths; and transmit a dynamic indication of an active sub-band selected from the multiple sub-bands.

Additionally, the wireless communication at the device 602 may include any one or combination of the multiple sub-bands are included in a widest sub-band among the multiple sub-bands. The full duplex sub-band configuration is a full duplex UL sub-band configuration indicating multiple UL sub-bands; the active sub-band is an active UL sub-band; and the processor is configured to receive an UL transmission from the UE within only the active UL sub-band in symbols configured based at least in part on the full duplex UL sub-band configuration. The processor is configured to transmit a DL transmission to the UE outside of the active UL sub-band in the symbols configured based at least in part on the full duplex UL sub-band configuration, wherein resource elements corresponding to the active UL sub-band are not available for the DL transmission. The full duplex sub-band configuration is a full duplex DL sub-band configuration indicating multiple DL sub-bands; the active sub-band is an active DL sub-band; and the processor is configured to transmit a DL transmission to the UE within only the active DL sub-band in symbols configured based at least in part on the full duplex DL sub-band configuration. The processor is configured to receive an UL transmission from the UE outside of the active DL sub-band in the symbols configured based at least in part on the full duplex DL sub-band configuration, wherein resource elements corresponding to the active DL sub-band are not available for the UL transmission. The multiple sub-bands include at least one sub-band with zero bandwidth. The processor is configured to determine a transport block size of a physical shared channel communicated outside of the active sub-band based at least in part on a number of PRBs allocated for the physical shared channel, excluding at least one of the PRBs overlapping with a time and frequency resource of the active sub-band. The dynamic indication of the active sub-band is transmitted in a MAC CE. The dynamic indication of the active sub-band is transmitted in DCI scheduling a physical shared channel. The dynamic indication of the active sub-band is transmitted in DCI activating a SPS physical shared channel. The processor is configured to transmit the full duplex sub-band configuration to a base station indicating an intended operation according to the multiple sub-bands of the multiple bandwidths. The indicating the intended operation includes the processor configured to indicate an intended active sub-band selected from the multiple sub-bands.

The processor 604 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 604 may be configured to operate a memory array using a memory controller. In some other implementations, a memory controller may be integrated into the processor 604. The processor 604 may be configured to execute computer-readable instructions stored in a memory (e.g., the memory 606) to cause the device 602 to perform various functions of the present disclosure.

The memory 606 may include random access memory (RAM) and read-only memory (ROM). The memory 606 may store computer-readable, computer-executable code including instructions that, when executed by the processor 604 cause the device 602 to perform various functions described herein. The code may be stored in a non-transitory computer-readable medium such as system memory or another type of memory. In some implementations, the code may not be directly executable by the processor 604 but may cause a computer (e.g., when compiled and executed) to perform functions described herein. In some implementations, the memory 606 may include, among other things, a basic I/O system (BIOS) which may control basic hardware or software operation such as the interaction with peripheral components or devices.

The I/O controller 610 may manage input and output signals for the device 602. The I/O controller 610 may also manage peripherals not integrated into the device M02. In some implementations, the I/O controller 610 may represent a physical connection or port to an external peripheral. In some implementations, the I/O controller 610 may utilize an operating system such as iOS®, ANDROID®, MS-DOS®, MS-WINDOWS®, OS/2®, UNIX®, LINUX®, or another known operating system. In some implementations, the I/O controller 610 may be implemented as part of a processor, such as the processor 604. In some implementations, a user may interact with the device 602 via the I/O controller 610 or via hardware components controlled by the I/O controller 610.

In some implementations, the device 602 may include a single antenna 612. However, in some other implementations, the device 602 may have more than one antenna 612 (i.e., multiple antennas), including multiple antenna panels or antenna arrays, which may be capable of concurrently transmitting or receiving multiple wireless transmissions. The transceiver 608 may communicate bi-directionally, via the one or more antennas 612, wired, or wireless links as described herein. For example, the transceiver 608 may represent a wireless transceiver and may communicate bi-directionally with another wireless transceiver. The transceiver 608 may also include a modem to modulate the packets, to provide the modulated packets to one or more antennas 612 for transmission, and to demodulate packets received from the one or more antennas 612.

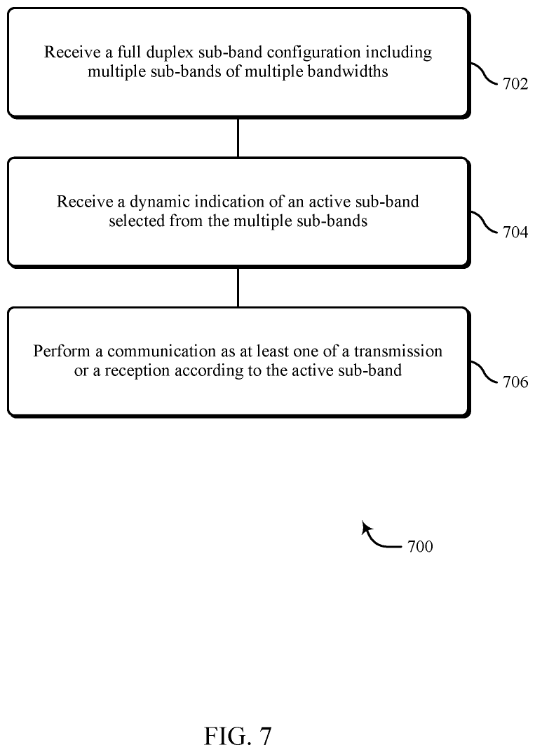

FIG. 7 illustrates a flowchart of a method 700 that supports sub-band full duplex operation in accordance with aspects of the present disclosure. The operations of the method 700 may be implemented by a device or its components as described herein. For example, the operations of the method 700 may be performed by a UE 104 as described with reference to FIGS. 1 through 6. In some implementations, the device may execute a set of instructions to control the function elements of the device to perform the described functions. Additionally, or alternatively, the device may perform aspects of the described functions using special-purpose hardware.

At 702, the method may include receiving a full duplex sub-band configuration including multiple sub-bands of multiple bandwidths. The operations of 702 may be performed in accordance with examples as described herein. In some implementations, aspects of the operations of 702 may be performed by a device as described with reference to FIG. 1.

At 704, the method may include receiving a dynamic indication of an active sub-band selected from the multiple sub-bands. The operations of 704 may be performed in accordance with examples as described herein. In some implementations, aspects of the operations of 704 may be performed by a device as described with reference to FIG. 1.

At 706, the method may include performing a communication as at least one of a transmission or a reception according to the active sub-band. The operations of 706 may be performed in accordance with examples as described herein. In some implementations, aspects of the operations of 706 may be performed by a device as described with reference to FIG. 1.

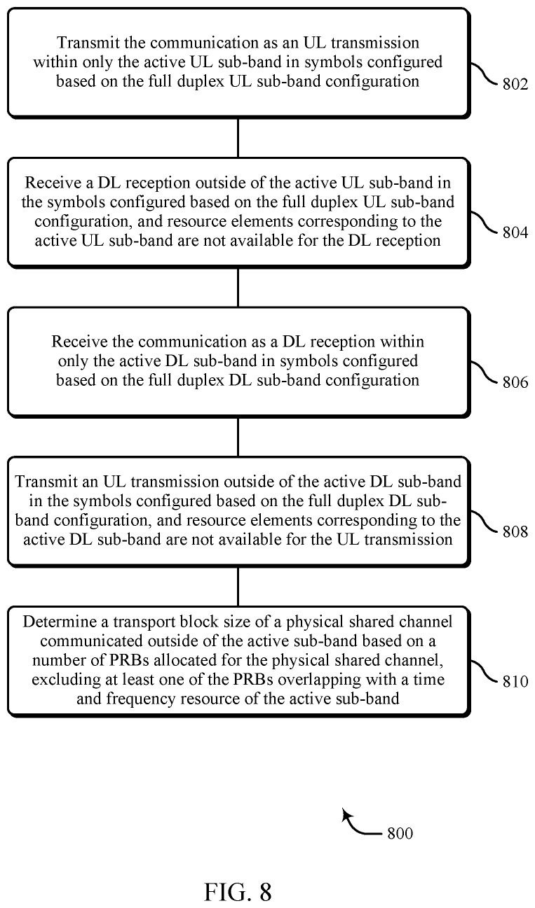

FIG. 8 illustrates a flowchart of a method 800 that supports sub-band full duplex operation in accordance with aspects of the present disclosure. The operations of the method 800 may be implemented by a device or its components as described herein. For example, the operations of the method 800 may be performed by a UE 104 as described with reference to FIGS. 1 through 6. In some implementations, the device may execute a set of instructions to control the function elements of the device to perform the described functions. Additionally, or alternatively, the device may perform aspects of the described functions using special-purpose hardware.

At 802, the method may include transmitting the communication as an UL transmission within only the active UL sub-band in symbols configured based on the full duplex UL sub-band configuration. The operations of 802 may be performed in accordance with examples as described herein. In some implementations, aspects of the operations of 802 may be performed by a device as described with reference to FIG. 1.

At 804, the method may include receiving a DL reception outside of the active UL sub-band in the symbols configured based on the full duplex UL sub-band configuration, and resource elements corresponding to the active UL sub-band are not available for the DL reception. The operations of 804 may be performed in accordance with examples as described herein. In some implementations, aspects of the operations of 804 may be performed by a device as described with reference to FIG. 1.

At 806, the method may include receiving the communication as a DL reception within only the active DL sub-band in symbols configured based on the full duplex DL sub-band configuration. The operations of 806 may be performed in accordance with examples as described herein. In some implementations, aspects of the operations of 806 may be performed by a device as described with reference to FIG. 1.

At 808, the method may include transmitting an UL transmission outside of the active DL sub-band in the symbols configured based on the full duplex DL sub-band configuration, and resource elements corresponding to the active DL sub-band are not available for the UL transmission. The operations of 808 may be performed in accordance with examples as described herein. In some implementations, aspects of the operations of 808 may be performed by a device as described with reference to FIG. 1.

At 810, the method may include determining a transport block size of a physical shared channel communicated outside of the active sub-band based on a number of PRBs allocated for the physical shared channel, excluding at least one of the PRBs overlapping with a time and frequency resource of the active sub-band. The operations of 810 may be performed in accordance with examples as described herein. In some implementations, aspects of the operations of 810 may be performed by a device as described with reference to FIG. 1.

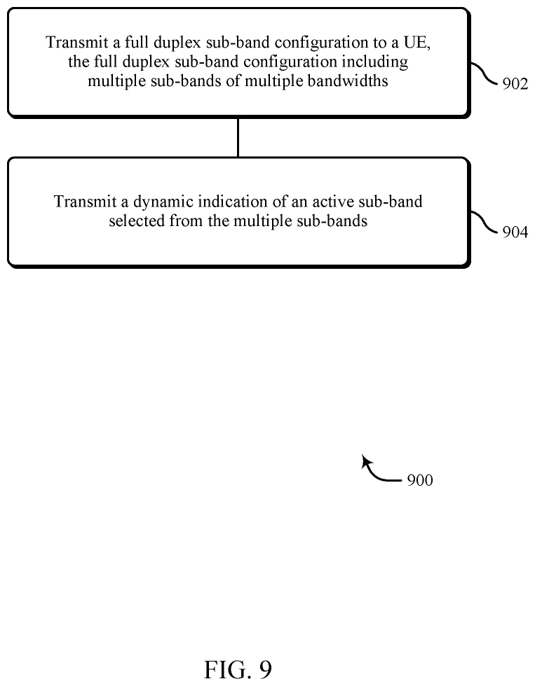

FIG. 9 illustrates a flowchart of a method 900 that supports sub-band full duplex operation in accordance with aspects of the present disclosure. The operations of the method 900 may be implemented by a device or its components as described herein. For example, the operations of the method 900 may be performed by a network entity 102, such as a base station as described with reference to FIGS. 1 through 6. In some implementations, the device may execute a set of instructions to control the function elements of the device to perform the described functions. Additionally, or alternatively, the device may perform aspects of the described functions using special-purpose hardware.

At 902, the method may include transmitting a full duplex sub-band configuration to a UE, the full duplex sub-band configuration including multiple sub-bands of multiple bandwidths. The operations of 902 may be performed in accordance with examples as described herein. In some implementations, aspects of the operations of 902 may be performed by a device as described with reference to FIG. 1.

At 904, the method may include transmitting a dynamic indication of an active sub-band selected from the multiple sub-bands. The operations of 904 may be performed in accordance with examples as described herein. In some implementations, aspects of the operations of 904 may be performed by a device as described with reference to FIG. 1.

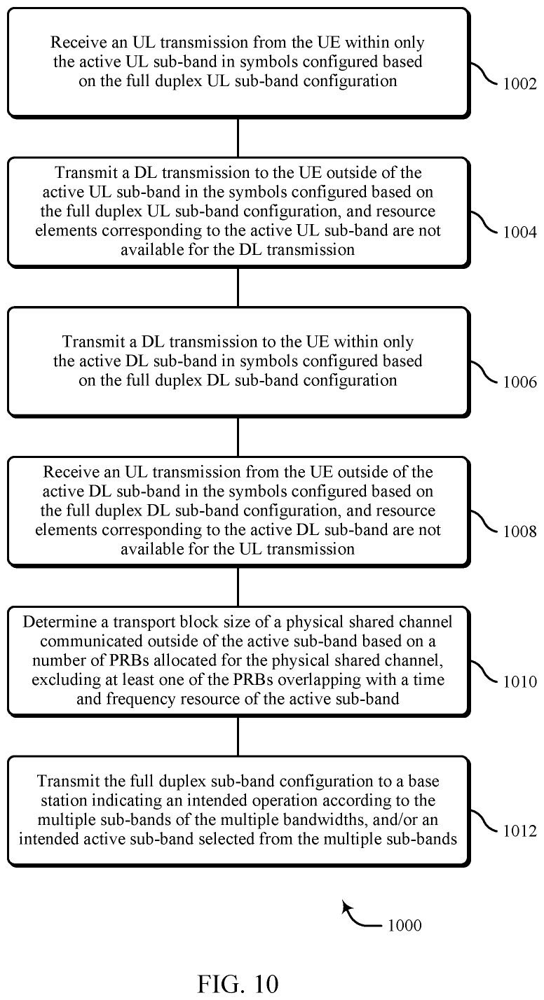

FIG. 10 illustrates a flowchart of a method 1000 that supports sub-band full duplex operation in accordance with aspects of the present disclosure. The operations of the method 1000 may be implemented by a device or its components as described herein. For example, the operations of the method 1000 may be performed by a network entity 102, such as a base station as described with reference to FIGS. 1 through 6. In some implementations, the device may execute a set of instructions to control the function elements of the device to perform the described functions. Additionally, or alternatively, the device may perform aspects of the described functions using special-purpose hardware.

At 1002, the method may include receiving an UL transmission from the UE within only the active UL sub-band in symbols configured based on the full duplex UL sub-band configuration. The operations of 1002 may be performed in accordance with examples as described herein. In some implementations, aspects of the operations of 1002 may be performed by a device as described with reference to FIG. 1.

At 1004, the method may include transmitting a DL transmission to the UE outside of the active UL sub-band in the symbols configured based on the full duplex UL sub-band configuration, and resource elements corresponding to the active UL sub-band are not available for the DL transmission. The operations of 1004 may be performed in accordance with examples as described herein. In some implementations, aspects of the operations of 1004 may be performed by a device as described with reference to FIG. 1.

At 1006, the method may include transmitting a DL transmission to the UE within only the active DL sub-band in symbols configured based on the full duplex DL sub-band configuration. The operations of 1006 may be performed in accordance with examples as described herein. In some implementations, aspects of the operations of 1006 may be performed by a device as described with reference to FIG. 1.

At 1008, the method may include receiving an UL transmission from the UE outside of the active DL sub-band in the symbols configured based on the full duplex DL sub-band configuration, and resource elements corresponding to the active DL sub-band are not available for the UL transmission. The operations of 1008 may be performed in accordance with examples as described herein. In some implementations, aspects of the operations of 1008 may be performed by a device as described with reference to FIG. 1.

At 1010, the method may include determining a transport block size of a physical shared channel communicated outside of the active sub-band based on a number of PRBs allocated for the physical shared channel, excluding at least one of the PRBs overlapping with a time and frequency resource of the active sub-band. The operations of 1010 may be performed in accordance with examples as described herein. In some implementations, aspects of the operations of 1010 may be performed by a device as described with reference to FIG. 1.

At 1012, the method may include transmitting the full duplex sub-band configuration to a base station indicating an intended operation according to the multiple sub-bands of the multiple bandwidths, and/or an intended active sub-band selected from the multiple sub-bands. The operations of 1012 may be performed in accordance with examples as described herein. In some implementations, aspects of the operations of 1012 may be performed by a device as described with reference to FIG. 1.

It should be noted that the methods described herein describe possible implementations, and that the operations and the steps may be rearranged or otherwise modified and that other implementations are possible. Further, aspects from two or more of the methods may be combined.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor.

Any connection may be properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Similarly, a list of one or more of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on”. Further, as used herein, including in the claims, a “set” may include one or more elements.

The terms “transmitting,” “receiving,” or “communicating,” when referring to a network entity, may refer to any portion of a network entity (e.g., a base station, a CU, a DU, a RU) of a RAN communicating with another device (e.g., directly or via one or more other network entities).

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form to avoid obscuring the concepts of the described example.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A user equipment (UE) for wireless communication, comprising:
at least one memory; and
at least one processor coupled with the at least one memory and configured to cause the UE to:
receive a full duplex sub-band configuration including multiple sub-bands of multiple bandwidths;
receive a dynamic indication of an active sub-band selected from the multiple sub-bands; and
perform a communication as at least one of a transmission or a reception according to the active sub-band.

2. The UE of claim 1, wherein the multiple sub-bands are included in a widest sub-band among the multiple sub-bands.

3. The UE of claim 1, wherein:
the full duplex sub-band configuration is received as a full duplex uplink (UL) sub-band configuration indicating multiple UL sub-bands;
the active sub-band is an active UL sub-band; and
the at least one processor is configured to cause the UE to transmit the communication as an UL transmission within only the active UL sub-band in symbols configured based at least in part on the full duplex UL sub-band configuration.

4. The UE of claim 3, wherein the at least one processor is configured to cause the UE to receive a downlink (DL) reception outside of the active UL sub-band in the symbols configured based at least in part on the full duplex UL sub-band configuration, wherein resource elements corresponding to the active UL sub-band are not available for the DL reception.

5. The UE of claim 1, wherein:
the full duplex sub-band configuration is received as a full duplex downlink (DL) sub-band configuration indicating multiple DL sub-bands;
the active sub-band is an active DL sub-band; and
the at least one processor is configured to cause the UE to receive the communication as a DL reception within only the active DL sub-band in symbols configured based at least in part on the full duplex DL sub-band configuration.

6. The UE of claim 5, wherein the at least one processor is configured to cause the UE to transmit an uplink (UL) transmission outside of the active DL sub-band in the symbols configured based at least in part on the full duplex DL sub-band configuration, wherein resource elements corresponding to the active DL sub-band are not available for the UL transmission.

7. The UE of claim 1, wherein the multiple sub-bands include at least one sub-band with zero bandwidth.

8. The UE of claim 1, wherein the at least one processor is configured to cause the UE to determine a transport block size of a physical shared channel communicated outside of the active sub-band based at least in part on a number of physical resource blocks (PRBs) allocated for the physical shared channel, excluding at least one of the PRBs overlapping with a time and frequency resource of the active sub-band.

9. The UE of claim 1, wherein the dynamic indication of the active sub-band is received in at least one of:
a medium access control (MAC) control element (CE);
downlink control information (DCI) scheduling a physical shared channel; or
the DCI activating a semi-persistent scheduling (SPS) physical shared channel.

10. (canceled)

11. A network entity for wireless communication, comprising:
at least one memory; and
at least one processor coupled with the at least one memory and configured to cause the network entity to:
transmit, to a user equipment (UE), a full duplex sub-band configuration that includes multiple sub-bands of multiple bandwidths; and
transmit a dynamic indication of an active sub-band selected from the multiple sub-bands.

12. The network entity of claim 11, wherein the multiple sub-bands are included in a widest sub-band among the multiple sub-bands.

13. The network entity of claim 11, wherein:
the full duplex sub-band configuration is a full duplex uplink (UL) sub-band configuration indicating multiple UL sub-bands;
the active sub-band is an active UL sub-band; and
the at least one processor is configured to cause the network entity to receive, from the UE, an UL transmission within only the active UL sub-band in symbols configured based at least in part on the full duplex UL sub-band configuration.

14. The network entity of claim 13, wherein the at least one processor is configured to cause the network entity to transmit, to the UE, a downlink (DL) transmission outside of the active UL sub-band in the symbols configured based at least in part on the full duplex UL sub-band configuration, wherein resource elements corresponding to the active UL sub-band are not available for the DL transmission.

15. The network entity of claim 11, wherein:
the full duplex sub-band configuration is a full duplex downlink (DL) sub-band configuration indicating multiple DL sub-bands;
the active sub-band is an active DL sub-band; and
the at least one processor is configured to cause the network entity to transmit, to the UE, a DL transmission within only the active DL sub-band in symbols configured based at least in part on the full duplex DL sub-band configuration.

16. The network entity of claim 15, wherein the at least one processor is configured to cause the network entity to receive, from the UE, an uplink (UL) transmission outside of the active DL sub-band in the symbols configured based at least in part on the full duplex DL sub-band configuration, wherein resource elements corresponding to the active DL sub-band are not available for the UL transmission.

17. A method performed by a user equipment (UE), the method comprising:
receiving a full duplex sub-band configuration including multiple sub-bands of multiple bandwidths;
receiving a dynamic indication of an active sub-band selected from the multiple sub-bands; and
performing a communication as at least one of a transmission or a reception according to the active sub-band.

18. The method of claim 17, wherein the multiple sub-bands are included in a widest sub-band among the multiple sub-bands.

19. The method of claim 17, wherein:
the full duplex sub-band configuration is received as a full duplex uplink (UL) sub-band configuration indicating multiple UL sub-bands;
the active sub-band is an active UL sub-band; and
the method further comprising transmitting the communication as an UL transmission within only the active UL sub-band in symbols configured based at least in part on the full duplex UL sub-band configuration.

20. The method of claim 17, wherein:
the full duplex sub-band configuration is received as a full duplex downlink (DL) sub-band configuration indicating multiple DL sub-bands;
the active sub-band is an active DL sub-band; and
the method further comprising receiving the communication as a DL reception within only the active DL sub-band in symbols configured based at least in part on the full duplex DL sub-band configuration.

21. A method performed by a network entity, the method comprising:
transmitting, to a user equipment (UE), a full duplex sub-band configuration that includes multiple sub-bands of multiple bandwidths; and
transmit a dynamic indication of an active sub-band selected from the multiple sub-bands.
